(19) United States
(12) Patent Application Publication
(10) Pub. No.: US 2008/0006106 A1
(43) Pub. Date: Jan. 10, 2008

(54) ROTATING OPERATION UNIT

(75) Inventors: Masato YAMASAKI, Okayama (JP); Jun SATO, Okayama (JP)

Correspondence Address: PEARNE & GORDON LLP, 1801 EAST 9TH STREET, SUITE 1200, CLEVELAND, OH, 44114-3108, US

(73) Assignee: MATSUSHITA ELECTRIC INDUSTRIAL CO., LTD., Osaka (JP)

(21) Appl. No.: 11/744,943

(22) Filed: May 7, 2007

(30) Foreign Application Priority Data
Jul. 6, 2006 (JP) 2006-186414

(51) Int. Cl. F16H 35/18

(52) U.S. Cl. 74/10 R

(57) ABSTRACT

A rotating operation unit allows rotation of a set knob without changing an operating state of an electronic device by rotating the set knob while holding it down. A user can use this function to rotate the set knob for adjusting an indication on the set knob to an upright position.

### BACKGROUND OF THE INVENTION

1. Field of the Invention

The present invention relates to rotating operation units employed in input operation sections of a range of electronic devices.

2. Background Art

Recently, rotating operation units to which a set knob is fixed at a tip of a rotating shaft have been often employed in input operation sections of car audio equipment. A user first presses the set knob to turn on power, and then rotates the set knob to a desired volume level.

FIG. 7 shows conventional car audio equipment 251 in which rotating operation unit 252 is installed. Set knob 254 protrudes from a front panel in a way such that set knob 254 can be operated. As shown in FIG. 8, design 255 with directionality which indicates a function of set knob 254 is provided on a front face of set knob 254.

An incremental encoder (not illustrated) with a push momentary switch is used as the rotating operation unit. The push momentary switch is turned on from off by pressing the rotating shaft of the incremental encoder in an axial direction. When pressing force is released, the switch is turned off from on. A microprocessor (not illustrated) turns on and off power relative to a signal from the push momentary switch. The microprocessor also identifies a rotating direction of the rotating shaft based on a phase difference of two-phase pulse signals generated by the incremental encoder, and sets a volume level in accordance with the number of pulse signals generated.

One of known prior arts related to the present invention is Japanese Patent Unexamined Publication No. 2000-184479.

In case of the above conventional rotating operation unit, however, design 255 remains tilted, as shown in FIG. 9, after the user rotates the set knob. This gives the user unbalanced feeling and a sense of degraded appearance quality.

### SUMMARY OF THE INVENTION

A rotating operation unit of the present invention includes an incremental encoder with a push momentary switch and a set knob fixed to a rotating shaft of the encoder. The encoder has the rotating shaft which can be pressed and rotated. A design with directionality is provided on the set knob.

The set knob can be rotated without changing an operating state of an electronic device by rotating the set knob while holding down the set knob. Accordingly, a user can correct a direction of the design on the set knob, when tilted, to an upright position by rotating the set knob while holding it down.

### BRIEF DESCRIPTION OF THE DRAWINGS

FIG. 1 is an operation flow chart of car audio equipment in which a rotating operation unit is installed in accordance with an exemplary embodiment of the present invention.

FIG. 2 is a chart illustrating a signal of a push momentary switch.

FIG. 3 is a chart illustrating a signal of the push momentary switch.

FIG. 4 is a chart illustrating adjustment of a volume level.

FIG. 5 is a chart illustrating positional adjustment of a set knob.

FIG. 6 is a front view of the set knob.

FIG. 7 is an external view of conventional car audio equipment.

FIG. 8 is a front view of a set knob.

FIG. 9 is the set knob in a rotated state.

### DETAILED DESCRIPTION OF THE INVENTION

An exemplary embodiment of the present invention is described below with reference to drawings.

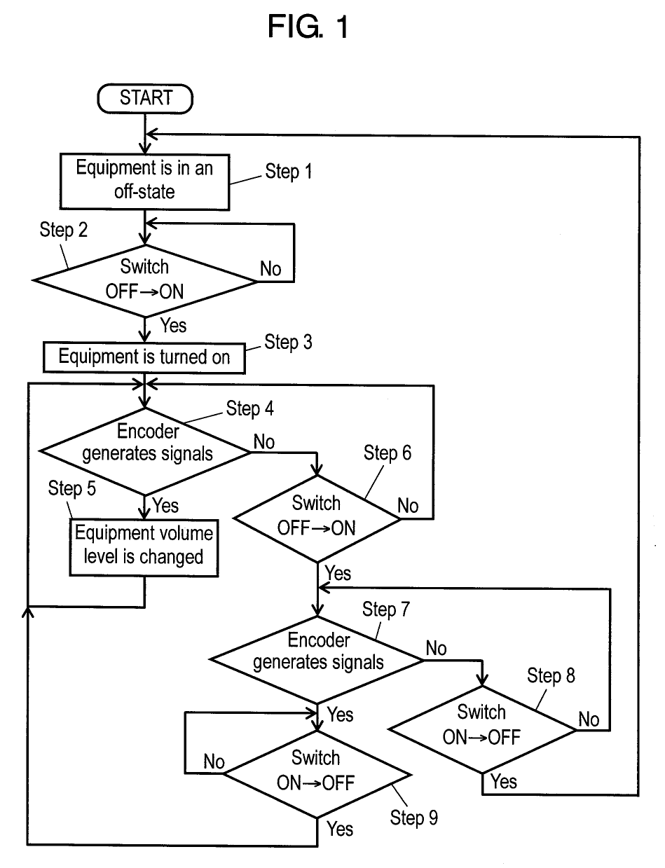

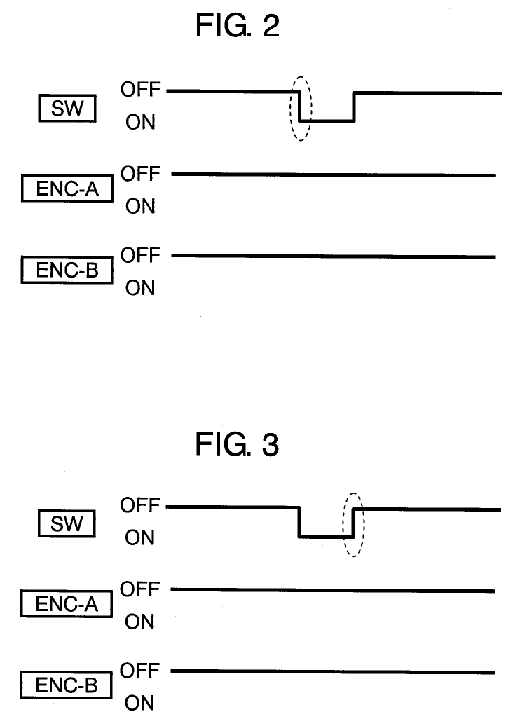

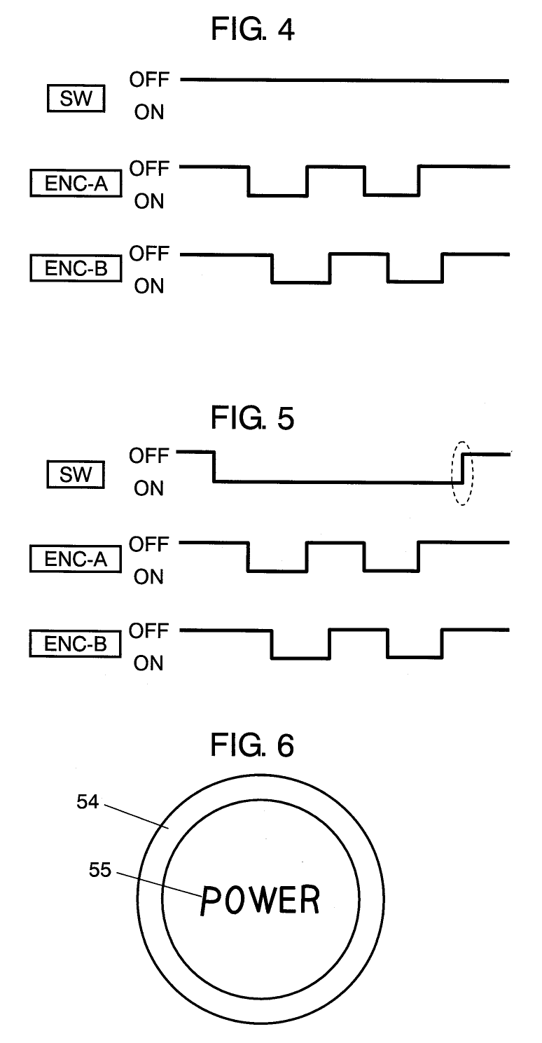

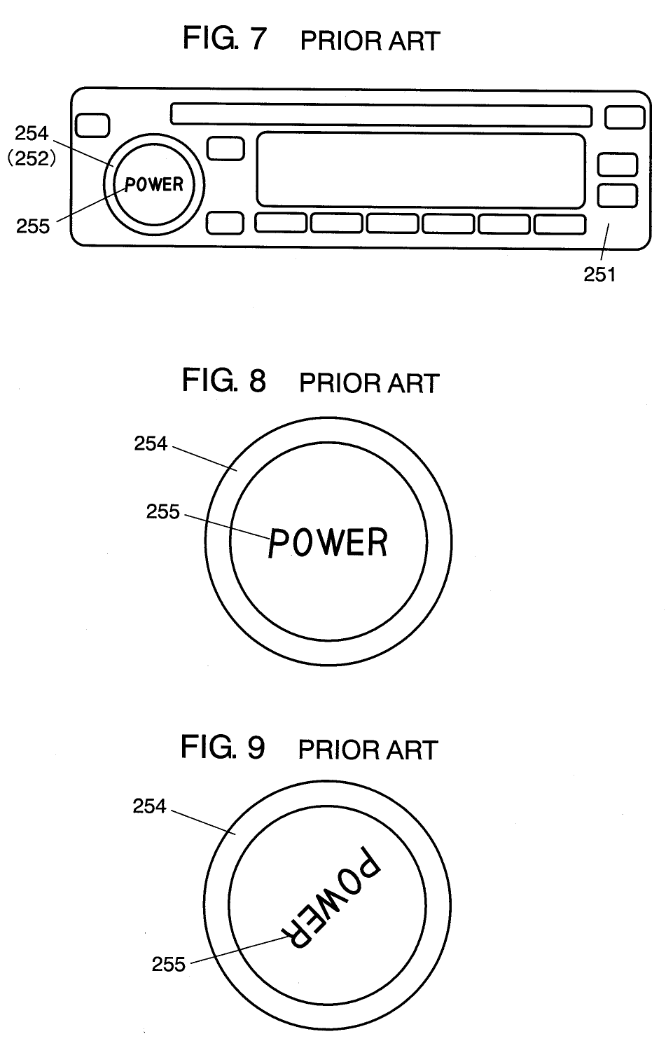

FIG. 1 is an operation flow chart of a rotating operation unit in the exemplary embodiment of the present invention. FIGS. 2 and 3 are charts illustrating a signal of a push momentary switch. FIG. 4 is a chart illustrating adjustment of a volume level.

FIG. 5 is a chart illustrating positional adjustment of a set knob. FIG. 6 is a front view of the set knob.

In FIGS. 2 to 5, code SW shows On/Off signals of the push momentary switch.

Codes ENC-A and ENC-B show A-phase signals and B-phase signals of an incremental encoder, respectively.

Same as the prior art, the rotating operation unit in this exemplary embodiment includes the incremental encoder with push momentary switch and the set knob fixed to a tip of a rotating shaft of the incremental encoder. A design 55 with directionality is provided on the set knob 54. A user operates the set knob 54 protruding from a front panel of an electronic device.

The rotating operation unit in this exemplary embodiment is characterized by its operation process, and thus the operation process is detailed next with reference to FIG. 1.

(Step 1) Power of car audio equipment is in an off-state.

(Step 2) A microprocessor (this is activated also during the above power-off state) monitors the push momentary switch. Unless an On signal is generated from the push momentary switch, Step 2 is repeated. When the push memory switch is turned on from off (dashed line in FIG. 2) by pressing the set knob, the operation proceeds to Step 3.

(Step 3) The power of the car audio equipment is turned on.

(Step 4) The microprocessor monitors the incremental encoder. When no pulse signal is generated from the incremental encoder, the operation proceeds to Step 6. When the incremental encoder generates the pulse signal (see FIG. 4) by rotating the set knob, the operation proceeds to Step 5.

(Step 5) The volume level of the car audio equipment is changed in accordance with the number of pulse signals generated by the incremental encoder. The operation then returns to Step 4.

(Step 6) The microprocessor monitors the push momentary switch. When the push momentary switch does not generate an On signal, the operation returns to Step 4. When the push momentary switch is turned on from off by pressing the set knob, the operation proceeds to Step 7.

(Step 7) In Step 7, the operation is determined in a state that the set knob is pressed, which means that the push-memory switch is continuously turned on. The microprocessor monitors the incremental encoder. When the incremental encoder does not generate the pulse signal, the operation proceeds to Step 8. When the incremental encoder generates the pulse signal (FIG. 5) by rotating the set knob while holding it down, the operation proceeds to Step 9.

(Step 8) The microprocessor monitors the push momentary switch. When the push momentary switch does not generate an Off signal, the operation returns to Step 7. When the push momentary switch is turned off from on (dashed line in FIG. 3) so as to turn off the power of the car audio equipment by releasing pressing force applied to the set knob, the operation returns to Step 1.

(Step 9) The microprocessor monitors the push momentary switch. Unless the push momentary switch generates an Off signal, Step 9 is repeated. When the push momentary switch is turned off from on (dashed line in FIG. 5) by releasing the pressing force applied to the set knob, the operation returns to Step 4.

The rotating operation unit in the exemplary embodiment is controlled such that the pulse signal of the incremental encoder is not counted, for example, when the set knob is rotated while holding down the set knob. This allows the rotation of the set knob without changing the volume level or the power-on state of the car audio equipment. This function is described in the above steps 6, 7, and 9.

Accordingly, the user can utilize this function to adjust the direction of the design placed on the set knob to an upright position, as shown in FIG. 6.

As described above, the rotating operation unit of the present invention can correct tilted indication on the set knob without changing the operating state of an electronic device. The present invention is thus effectively applicable to input operation sections of a range of electronic devices.

What is claimed is:

1. A rotating operation unit comprising:
an incremental encoder with a push momentary switch, the incremental encoder including a rotating shaft which can be pressed and rotated; and
a set knob on which a design with directionality is provided, the set knob being fixed to the rotating shaft of the incremental encoder;
wherein
the rotating operation unit activates a predetermined function by actuating the incremental encoder through an operation of the set knob; and
the rotating operation unit is controlled such that an operating state of the predetermined function, activated by rotating the set knob for a required degree, is maintained without being changed when the set knob is rotated while an on-state of the push momentary switch is maintained by pressing the set knob.
